(19) United States
(12) Patent Application Publication
(10) Pub. No.: US 2014/0204333 A1
(43) Pub. Date: Jul. 24, 2014

(54) ADJUSTABLE ELECTRO-ACTIVE OPTICAL SYSTEM AND USES THEREOF

(71) Applicant: PixelOptics, Inc, (US)

(72) Inventors: Ronald Blum, Roanoke, VA (US); Amitava Gupta, Roanoke, VA (US); William Kokonaski, Gig Harbor, WA (US)

(73) Assignee: PixelOptics, Inc, Roanoke, VA (US)

(21) Appl. No.: 13/848,330

(22) Filed: Mar. 21, 2013

Related U.S. Application Data
(60) Provisional application No. 61/614,026, filed on Mar. 22, 2012.

(51) Int. Cl. G02C 7/06

(52) U.S. Cl. CPC G02C 7/061
USPC 351/55

(57) ABSTRACT

The present invention relates generally to electro-active optical systems, such as a pair of spectacles having one or more lenses that employ electro-active optical structures. In some embodiments, the invention relates to electro-active optical systems whose position can be adjusted relative to a wearer's face. In some embodiments, the invention relates to methods of performing such adjustments.

### CROSS-REFERENCE TO RELATED APPLICATIONS

The present application claims the benefit of priority to U.S. Provisional Patent Application No. 61/614,026, filed Mar. 22, 2012, which is hereby incorporated by reference as though fully set forth herein.

### FIELD OF THE INVENTION

The present invention relates generally to electro-active optical systems, such as a pair of spectacles having one or more lenses that employ electro-active optical structures. In some embodiments, the invention relates to electro-active optical systems whose position can be adjusted relative to a wearer's face. In some embodiments, the invention relates to methods of performing such adjustments.

### BACKGROUND

Progressive addition lenses have been used for a number of years to correct for certain conditions, such as presbyopia, a condition resulting in difficulty focusing on near objects. But such multi-focal lenses provide only static correction, not dynamic correction. Electro-active lenses can be used to help the performance of multi-focal lenses, for example, by providing dynamic focusing power that allows for a much weaker progressive lens to be used to provide intermediate correction, as well as part of the near field vision correction. This permits the lens to have weaker total static power progression, which is more forgiving than a traditional progressive addition lens.

The magnitude of refractive correction required to achieve ideal acuity can change depending on the level of ambient illumination, at least for some subjects. This condition can be referred to as “night myopia.” In such cases, the refractive error measured under scotopic conditions can be different from that measured under photopic conditions. In such instances, a pair of spectacles prescribed for daytime use may provide subpar visual performance when used at night.

Therefore, it may be desirable to develop a pair of spectacles that can provide ideal visual acuity during daytime and nighttime conditions, even for those who suffer from night myopia.

### SUMMARY OF THE INVENTION

In at least one aspect, the invention provides a pair of spectacles comprising: a frame; a first lens and a second lens, each of which is disposed in the frame, wherein the first lens comprises an electro-active optical zone; and a translation mechanism, which is adapted to translate the first lens vertically with respect to a wearer's face.

In another aspect, the invention provides methods of correcting for night-time vision in a subject, comprising: providing a pair of spectacles of any embodiment of the previous aspect of the invention; and translating the spectacles up or down the wearer's face in response to light conditions.

Further aspects and embodiments of the invention are provided in the detailed description that follows and in the accompanying figures.

### BRIEF DESCRIPTION OF DRAWINGS

The application includes the following figures. These figures depicts certain illustrative embodiments of various aspects of the invention. In some instances, the figures do not necessarily provide a proportional illustration of an actual embodiment of the invention, but may emphasize certain features for purposes of illustration. The figures are not intended to limit the scope of the claimed subject matter apart from an express indication to the contrary.

FIG. 1 depicts a lens having an electro-active optical zone, a scotopic correction zone, and a photopic correction zone, where the scotopic correction zone and the photopic correction zone are within the electro-active optical zone.

FIG. 2 depicts a lens having an electro-active optical zone, a scotopic correction zone, and a photopic correction zone, where the scotopic correction zone is within the electro-active optical zone.

FIG. 3 depicts a lens having an electro-active optical zone, a scotopic correction zone, and a photopic correction zone, where the photopic correction zone is within the electro-active optical zone.

FIG. 4 depicts a pair of spectacles where the frame has a translation mechanism that is adapted to translate the frame vertically up or down a wearer's face.

FIG. 5 depicts a flow chart for a method of correcting for night vision using a pair of spectacles having an electro-active optical zone.

FIG. 6 depicts a flow chart for a method of correcting for night vision using a pair of spectacles having an electro-active optical zone.

### DETAILED DESCRIPTION

The following description recites various aspects and embodiments of the present invention. No particular embodiment is intended to define the scope of the invention. Rather, the embodiments merely provide non-limiting examples various compositions, apparatuses, and methods that are at least included within the scope of the invention. The description is to be read from the perspective of one of ordinary skill in the art; therefore, information well known to the skilled artisan is not necessarily included.

As used herein, the articles “a,” “an,” and “the” include plural referents, unless expressly and unequivocally disclaimed.

As used herein, the conjunction “or” does not imply a disjunctive set. Thus, the phrase “A or B is present” includes each of the following scenarios: (a) A is present and B is not present; (b) A is not present and B is present; and (c) A and B are both present. Thus, the term “or” does not imply an either/or situation, unless expressly indicated.

As used herein, the term “comprise,” “comprises,” or “comprising” implies an open set, such that other elements can be present in addition to those expressly recited.

Unless otherwise indicated, all numbers expressing quantities of ingredients, reaction conditions, and so forth used in the specification are to be understood as being modified in all instances by the term “about.” Accordingly, unless indicated to the contrary, the numerical parameters set forth in the following specification are approximations that can vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more, e.g. 1 to 6.1, and ending with a maximum value of 10 or less, e.g., 5.5 to 10.

Night vision can be improved significantly by adjusting the distance prescription normally used for daytime correction by up to ±0.25, or up to ±0.50 diopters. In fact, it is believed that up to 70%, if not more, of presbyopic subjects can benefit from having separate best visual acuity (BVA) prescriptions for daytime and nighttime use. In certain embodiments of the invention, these separate BVA prescriptions are both included within the same spectacle lens, such that ideal visual acuity can be achieved under different light conditions by repositioning the spectacle lens or lenses relative to the wearer's pupil.

In at least one aspect, the invention provides a pair of spectacles comprising: a frame; a first lens and a second lens, each of which is disposed in the frame, wherein the first lens comprises an electro-active optical zone; and a translation mechanism, which is adapted to translate the first lens vertically with respect to a wearer's face.

In some embodiments, the first lens and the second lens are disposed in a frame. The invention is not limited to any particular frame design, as long as it provides physical support for the spectacles and assists in maintaining the proper positioning of the spectacles on the wearer's face for optimal vision correction. In some embodiments, the frame includes a structure that wraps around the entirety of the outer edges of the first lens and second lens. In other embodiments, the frame includes a structure that only wraps around a portion of the first lend and the second lens, e.g., the top of the lens and at least part of the two sides. In some other embodiments, the frame a structure that physically attaches to first lens and second lens. In some such embodiments, the frame includes no structure that wraps around any part of either the first lens or the second lens. In some embodiments, the frame comprises structures that permit electrical communication with the one or more electro-active optical structures disposed in the first lens or second lens, including various contacts, wires, and the like.

At least one of the lenses in the pair of spectacles comprises an electro-active optical zone. In some embodiments, both the first lens and the second lens comprise an electro-active optical zone. Lenses having electro-active optical zones are generally described in various references, including U.S. Pat. Nos. 6,619,799; 7,290,875; 6,626,532; and 7,009,757; and U.S. Published Patent Application No. 2013/0027655, each of which are incorporated by reference as though fully set forth herein.

As used herein, an electro-active zone or an electro-active element refers to a device with an optical property that is alterable by the application of electrical energy. The alterable optical property may be, for example, optical power, focal length, diffraction efficiency, depth of field, optical transmittance, tinting, opacity, refractive index, chromatic dispersion, or a combination thereof. An electro-active element may be constructed from two substrates and an electro-active material disposed between the two substrates. The substrates may be shaped and sized to ensure that the electro-active material is contained within the substrates and cannot leak out. One or more electrodes may be disposed on each surface of the substrates that is in contact with the electro-active material. The electro-active element may include a power supply operably connected to a controller. The controller may be operably connected to the electrodes by way of electrical connections to apply one or more voltages to each of the electrodes. When electrical energy is applied to the electro-active material by way of the electrodes, the electro-active material's optical property may be altered. For example, when electrical energy is applied to the electro-active material by way of the electrodes, the electro-active material's index of refraction may be altered, thereby changing the optical power of the electro-active element.

The electro-active element or zone may be embedded within or attached to a surface of an ophthalmic lens to form an electro-active lens. Alternatively, the electro-active element may be embedded within or attached to a surface of an optic which provides substantially no optical power to form an electro-active optic. In such a case, the electro-active element or zone may be in optical communication with an ophthalmic lens, but separated or spaced apart from or not integral with the ophthalmic lens. The ophthalmic lens may be an optical substrate or a lens.

A “lens” is any device or portion of a device that causes light to converge or diverge (i.e., a lens is capable of focusing light). A lens may be refractive or diffractive, or a combination thereof. A lens may be concave, convex, or planar on one or both surfaces. A lens may be spherical, cylindrical, prismatic, or a combination thereof. A lens may be made of optical glass, plastic, thermoplastic resins, thermoset resins, a composite of glass and resin, or a composite of different optical grade resins or plastics. It should be pointed out that within the optical industry a device can be referred to as a lens even if it has zero optical power (known as piano or no optical power). In this cases, the lens can be referred to as a “plano lens.” A lens may be either conventional or non-conventional. A conventional lens corrects for conventional errors of the eye including lower order aberrations such as myopia, hyperopia, presbyopia, and regular astigmatism. A non-conventional lens corrects for non-conventional errors of the eye including higher order aberrations that can be caused by ocular layer irregularities or abnormalities. The lens may be a single focus lens or a multifocal lens such as a Progressive Addition Lens or a bifocal or trifocal lens. Contrastingly, an “optic,” as used herein, has substantially no optical power and is not capable of focusing light (either by refraction or diffraction). The term “refractive error” may refer to either conventional or non-conventional errors of the eye. It should be noted that redirecting light is not correcting a refractive error of the eye. Therefore, redirecting light to a healthy portion of the retina, for example, is not correcting a refractive error of the eye.

In some embodiments, the electro-active zone includes at least one cavity, which is filled with an electro-active material. Consistent with the above discussion, this cavity can be located at any suitable location. For example, in some embodiments, the cavity lies on the outer or inner surface of an ophthalmic lens. In other embodiments, the cavity lies in the interior of an ophthalmic lens. In general, the cavity is a sealed cavity, thereby preventing the electro-active material from leaving the cavity during everyday use. Any suitable electro-active material can be used, including any optically birefringent material, including, but not limited to, liquid crystals.

The electro-active zone can operate as a free-standing cell, meaning that it is capable of changing optical power in a standalone manner when electricity or an electrical potential is applied. The electro-active zone can be located in any suitable portion of the lens. In some embodiments, the electro-active zone is located in the entire viewing area of the electro-active lens, while, in other embodiments, it is located in just a portion thereof. The electro-active zone may be located near the top, middle, or bottom portion of the lens. It should be noted that the electro-active zone may be capable of focusing light on its own and does not need to be combined with an optical substrate or lens.

In certain embodiments, one or both lenses in the spectacles include certain zones that correct for refractive errors of the corresponding eye of a subject (i.e., a wearer). The following discussion will refer to the lens in the singular, it being understood that the features described can be implemented in both lenses of a pair of spectacles, with the degree of correction related to the refractive error present in the corresponding eye of the wearer.

In certain embodiments, the lens comprises a first zone, which corrects for the refractive error of a wearer's eye under scotopic conditions. As used herein, the term “scotopic conditions” refers to conditions where the luminance level is 1 cd/m² or less, for example, 10⁻⁶ cd/m² to 1 cd/m². Such conditions are typical of those experienced during outdoor nighttime activities, such as driving at night. The invention is not limited to any particular means of determining the refractive error of an eye under scotopic conditions. A number of techniques can be used, and are known to eye care professionals, such as optometrists and ophthalmologists.

In certain embodiments, the lens also comprises a second zone, which corrects for the refractive error of a wearer's eye under photopic conditions. As used herein, the term “photopic conditions” refers to conditions where the luminance level is greater than 1 cd/m². Such conditions are typical of those experienced during outdoor daytime activities. The invention is not limited to any particular means of determining the refractive error of an eye under photopic conditions. A number of techniques can be used, and are known to eye care professionals, such as optometrists and ophthalmologists.

In some embodiments, the lens comprises a first zone and a second zone (as described above). In such embodiments, the two zones may be positioned relative to each other on the lens in any suitable configuration. In some embodiments, the first zone and the second zone are positioned vertically with respect to each other. In some such embodiments, the first zone is above the second zone, from the perspective of a wearer of a pair of spectacles containing the lens. In some other embodiments, the first zone is below the second zone, from the perspective of a wearer of a pair of spectacles containing the lens. The two zones can be separated by any suitable distance. The distance selected may depend on various factors, including, but not limited to, the degree of correction in the lens, the difference in correction between the first zone and the second zone, the shape of the lens, such as its vertical height, and certain characteristics of the user. The distance between the two zones can be measured as a “center-to-center distance,” which is the vertical distance between the points in the first zone and second zone that line up with the pupil of the eye of a wearer when the eye is in a relaxed or unstressed state. In some embodiments, the center-to-center distance between the first zone and the second zone is from 2 to 10 mm, or from 3 to 7 mm, or from 4 to 6 mm.

In some embodiments, the first and second zones have a difference in correction. In some embodiments, the difference between the correction of the first and second zones is no more than ±1.0 OD, or no more than ±0.75 OD, or no more than ±0.50 OD, or no more than ±0.25 OD. In some embodiments, the difference between the correction of the first and second zones is from ±0.25 to ±0.75 OD, or from ±0.25 to ±0.50 OD.

The pair of spectacles comprises a translation mechanism, which is adapted to translate the first lens vertically with respect to a wearer's face. The translation mechanism can take on any suitable form, and is described in further detail below. In some embodiments, the translation mechanism is adapted to at least translate the first zone into and out of the field of vision of the wearer. In some embodiments, the translation mechanism is adapted to at least translate the first zone into and out of the field of vision of the wearer. In some embodiments, the translation mechanism is adapted to at least translate the first zone out of the field of vision of the wearer and translate the second zone into the field of vision of the wearer. Further, in some embodiments, the translation mechanism is also adapted to at least translate the second zone out of the field of vision of the wearer and translate the first zone into the field of vision of the wearer. In some embodiments, the translation occurs in response to changing ambient light conditions.

The lens can include any number of other zones, so long as such zones can be fit reasonably onto the lens. For example, in some embodiments, the lens can comprise an additional zone adapted to correct for refractive error of a wearer's eye under certain occupational conditions related to the wearer's occupation or certain hobbies or activities engaged in by the wearer. These additional zones can be placed in any suitable location on the lens relating to other zones. In some embodiments, any additional zones are disposed vertically on the lens with respect to either or both of the first zone or second zone.

The lens comprises an electro-active optical zone. In some embodiments, the electro-active optical zone comprises at least a portion (including the center) of the first zone. In some embodiments, the electro-active optical zone comprises at least a portion (including the center) of the second zone. In some embodiments, the electro-active optical zone comprises at least a portion (including the center) of the first zone and at least a portion (including the center) of the second zone.

As noted above, the pair of spectacles comprises a translation mechanism, which is adapted to translate the first lens vertically with respect to a wearer's face. This translation mechanism can have any suitable form. In some embodiments, the translation mechanism is adapted to translate the lens with respect to the wearer's face, but is not necessarily adapted to translate the frame with respect to the wearer's face. In some other embodiments, the translation mechanism is adapted to translate the lens with respect to the wearer's face, but is not necessarily adapted to translate the lens with respect to the frame.

In embodiments where the translation mechanism is adapted to translate the lens with respect to the wearer's face, but is not adapted to translate the frame with respect to the wearer's face, the translation mechanism can have any suitable form. For example, in some embodiments, the translation mechanism can be device that moves the lens up or down with respect to the frame. In some embodiments, the translation mechanism can be a mechanical device, which can be activated through, for example, a switch. In some other embodiments, the translation mechanism can be a small electric motor that translates the lens up or down with respect to the frame.

In embodiments where the translation mechanism is adapted to translate the lens with respect to the wearer's face by translating the frame, the translation mechanism can have any suitable form. In some embodiments, the translation mechanism is a mechanism that raises and lowers the frames by extending or retracting a piece that sits against the bridge of the wearer's nose. In some such embodiments, this can be done by a mechanical means, such as by a mechanical switch. In other embodiments, it can be done electronically, for example, by using a small electric motor in the frames to extend and retract the piece that sits against the bridge of the wearer's nose.

In some embodiments where the translation mechanism is an electric motor, the electric motor is in electrical communication with a controller. In such embodiments, the controller controls the translation of one or both lenses of the pair of spectacles relative to the wearer's face. In some embodiments, the controller is adapted to receive input from a wearer, for example, in response to changing light conditions. In such embodiments, the controller is in electrical communication with an input device that receives input from the wearer. In some other embodiments, the controller is adapted to receive input from a sensor, such as a photosensor that detects the level of ambient light experienced by the user.

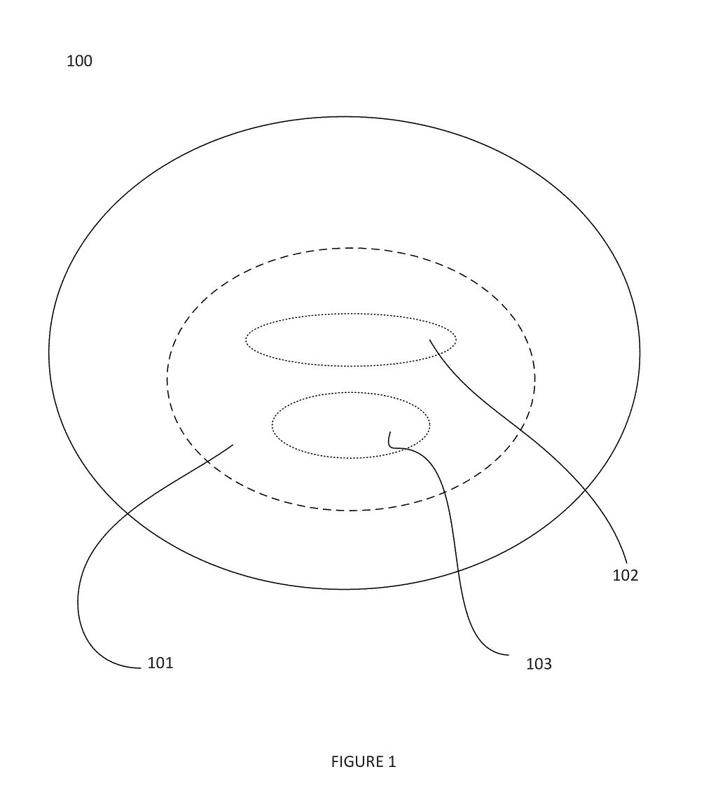

FIG. 1 depicts a lens 100 according to certain embodiments of the invention. The lens 100 has an electro-active zone 101, a photopic vision correction zone 102 that corrects for the refractive error of an eye under photopic conditions, and a scotopic vision correction zone 103 that corrects for the refractive error of an eye under scotopic conditions.

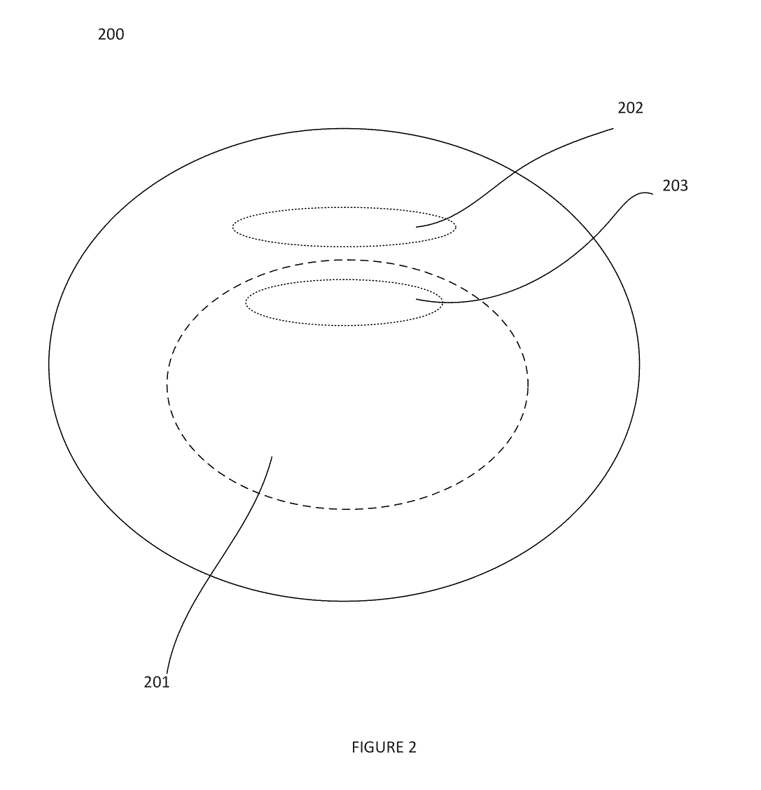

FIG. 2 depicts a lens 200 according to certain embodiments of the invention. The lens 200 has an electro-active zone 201, a photopic vision correction zone 202 that corrects for the refractive error of an eye under photopic conditions, and a scotopic vision correction zone 203 that corrects for the refractive error of an eye under scotopic conditions.

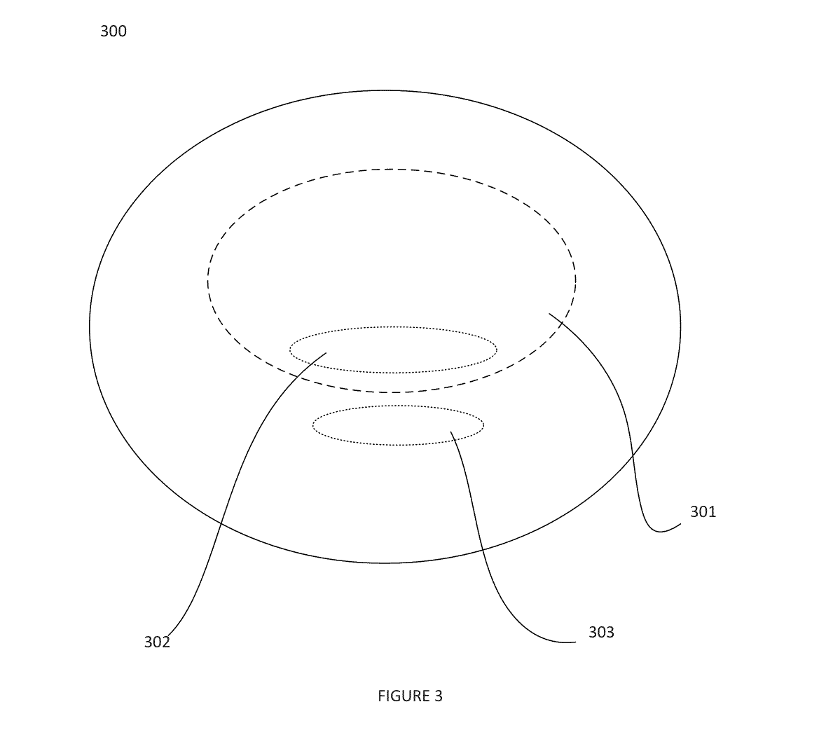

FIG. 3 depicts a lens 300 according to certain embodiments of the invention. The lens 300 has an electro-active zone 301, a photopic vision correction zone 302 that corrects for the refractive error of an eye under photopic conditions, and a scotopic vision correction zone 303 that corrects for the refractive error of an eye under scotopic conditions.

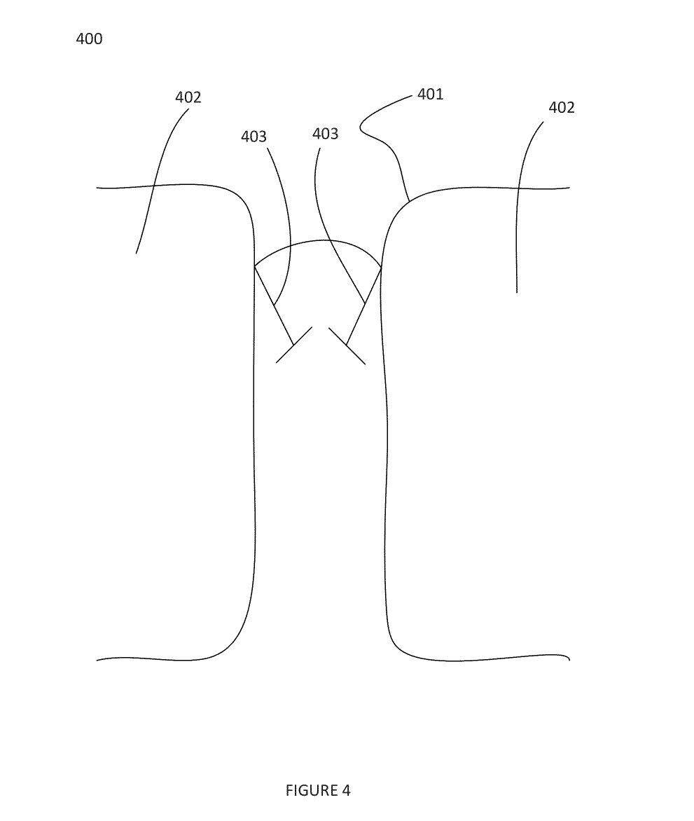

FIG. 4 depicts a pair of spectacles 400 according to certain embodiments of the invention. The frame 401 has two lenses 402 disposed therein, and has a nosepiece 403 that is adapted to translate vertically, so as to be able to adjust the lenses 402 vertically relative to a wearer's face.

In another aspect, the invention provides methods of correcting for night-time vision in a subject, comprising: providing a pair of spectacles according to any of the aforementioned embodiments; and translating the spectacles up or down relative to the wearer's face in response to light conditions.

This translating step can be carried out in any suitable manner. In some embodiments, the translating comprises translating the lens with respect to the wearer's face, but is not necessarily translating the frame with respect to the wearer's face. In some other embodiments, the translating comprises translating the lens with respect to the wearer's face, but not necessarily translating the lens with respect to the frame.

The translating can be carried out by activating a translation mechanism, such as any described above. In some embodiments, the translating is initiated manually by the wearer, for example, by mechanically moving a switch, or by inputting information into an input device that is in electrical communication via a controller with a small motor that performs the actual translation of the lens or lenses.

In some other embodiments, the translating is initiated by the output of a photosensor that is in electrical communication via a controller with a small motor that performs the actual translation of the lens or lenses. In some embodiments, the controller comprises a processor that evaluates the output of the photosensor, determines whether any translation of one or both lenses is warranted, and, if translation is warranted, translating one or both lenses vertically relative to the wearer's face. The determining can be carried out by any suitable algorithm. For example, in some embodiments, the controller determines whether or not wearer is experiencing scotopic light conditions, and, if so, translates one or both lenses so that a scotopic vision correction zone is within the wearer's line of sight (when the eye is in a neutral posture). When the user is not experiencing scotopic light conditions, the controller translates one or both lenses so that the scotopic vision correction zone is not within the wearer's line of sight, and, in some embodiments, translates a photopic vision correction zone into the wearer's line of sight.

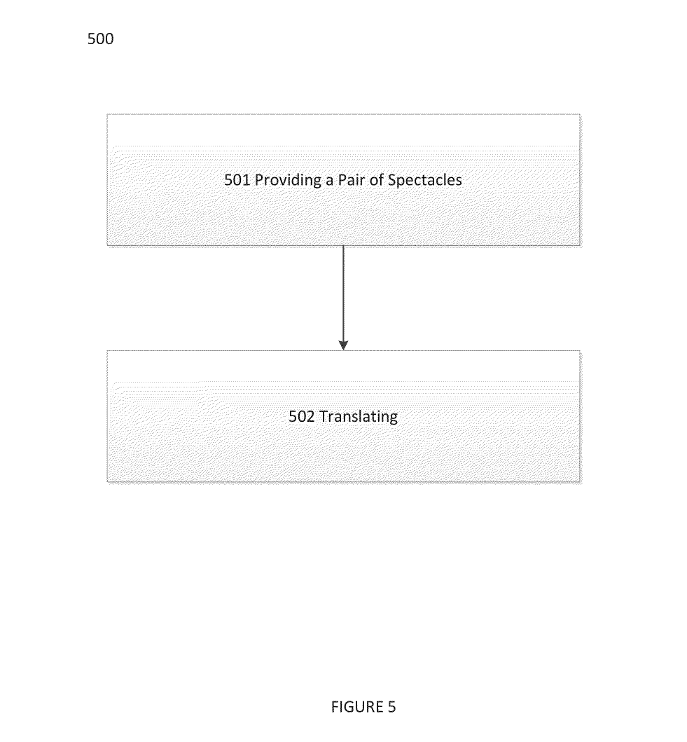

FIG. 5 depicts a flow chart showing an embodiment of the invention of a method of correcting for night-time vision in a subject 500, comprising: providing a pair of spectacles according to any of the aforementioned embodiments 501; and translating the spectacles up or down relative to the wearer's face in response to light conditions 502.

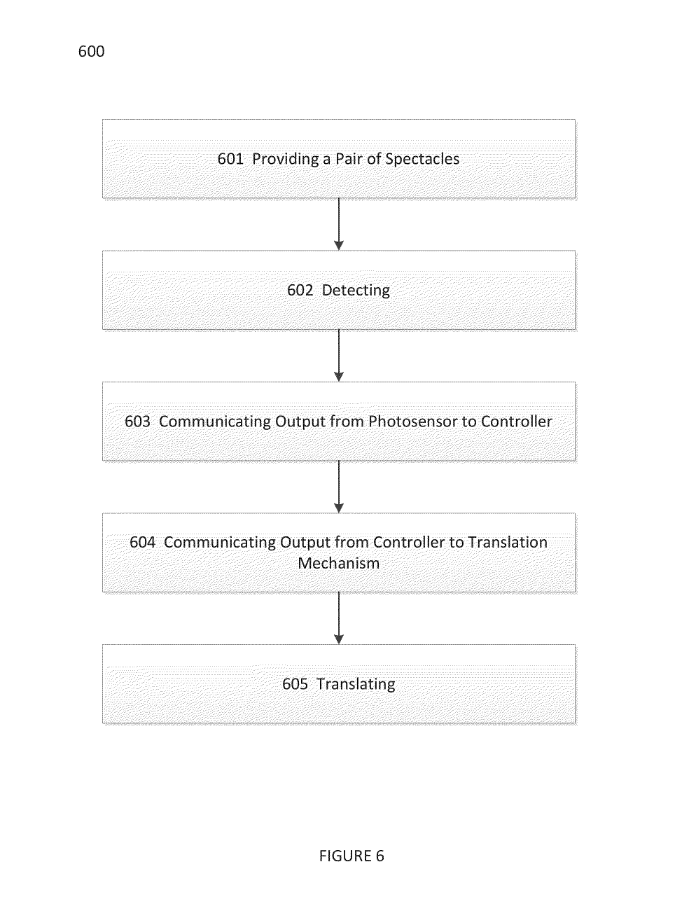

FIG. 6 depicts a flow chart showing an embodiment of the invention of a method of correcting for night-time vision in a subject 600, comprising: providing a pair of spectacles having a photosensor, a controller, and a translation mechanism 601; detecting the presence of scotopic ambient light conditions using the photosensor 602; communicating an output from the photosensor to the controller 603; communicating an output from the controller to the translation mechanism 604; and translating the spectacles up or down relative to the wearer's face using the translation mechanism 605.

### EXAMPLES

A clinical investigation was conducted on early-to-mid-range presbyopes. The study included 14 participants, with ages ranging from 36 to 55 (mean of 44.7). Nine were male, and five were female. The subjects had a mean SE correcting ranging from −2.25 D to +3.25 D with a mean of −0.67 D. The subjects had a mean Cyl correction ranging from 0 D to −1.00 D with a mean of −0.25 D. Vision was tested using toe CoViTS vision testing system at target backgrounds of 0.28 cd/m² (dim) and 14.6 cd/m² (bright). Defocus curves were prepared for the dominant eye, and it was determined for each subject the degree of shift in the refractive error experienced by the subject under dim conditions versus bright conditions. The shifts ranged from −0.50 OD (myopic shift) to +0.50 OD (hyperoptic shift).

1. A pair of spectacles comprising:
a frame;
a first lens and a second lens, each of which is disposed in the frame, wherein the first lens comprises an electro-active changeable focus optical zone; and
a translation mechanism, which is adapted to translate the first lens vertically with respect to a wearer's face.

2. The pair of spectacles of claim 1, wherein the translation mechanism is adapted to translate the electro-active changeable focus optical zone of the first lens into and out of the wearer's field of vision.

3. The pair of spectacles of claim 1, wherein the first lens comprises a first zone, which corrects for the refractive error of a first eye of the wearer under scotopic conditions.

4. The pair of spectacles of claim 1, wherein the first lens comprises a second zone, which corrects for the refractive error of a first eye of the wearer under photopic conditions.

5. The pair of spectacles of claim 4, wherein the first zone and the second zone of the first lens are positioned vertically with respect to each other.

6. The pair of spectacles of claim 5, wherein a center-to-center distance between the first zone and the second zone of the first lens is 3 to 7 mm.

7. The pair of spectacles of claim 5, wherein the difference in the correction between the first zone and the second zone of the first lens is ±0.5 OD.

8. The pair of spectacles of claim 3, wherein the translation mechanism is adapted to translate the first zone of the first lens into and out of the wearer's field of vision.

9. The pair of spectacles of claim 4, wherein the translation mechanism is adapted to translate the second zone of the first lens into and out of the wearer's field of vision.

10. The pair of spectacles of claim 1, wherein the second lens comprises an electro-active changeable focus optical zone.

11. The pair of spectacles of claim 10, wherein the translation mechanism is adapted to translate the electro-active changeable focus optical zone of the second lens into and out of the wearer's field of vision.

12. The pair of spectacles of claim 10, wherein the second lens comprises a first zone, which corrects for the refractive error of a second eye of the wearer under scotopic conditions.

13. The pair of spectacles of claim 12, wherein the second lens comprises a second zone, which corrects for the refractive error of a second eye of the wearer under photopic conditions.

14. The pair of spectacles of claim 13, wherein the first zone and the second zone of the second lens are positioned vertically with respect to each other.

15. The pair of spectacles of claim 12, wherein the translation mechanism is adapted to translate the first zone of the second lens into and out of the wearer's field of vision.

16. The pair of spectacles of claim 13, wherein the translation mechanism is adapted to translate the second zone of the second lens into and out of the wearer's field of vision.

17. The pair of spectacles of claim 14, wherein a center-to-center distance between the first zone and the second zone of the second lens is 3 to 7 mm.

18. The pair of spectacles of claim 14, wherein the difference in the correction between the first zone and the second zone of the second lens is ±0.5 OD.

19. The pair of spectacles of claim 1, further comprising a photosensor, wherein the photosensor is in electrical communication with the translation mechanism.

20. The pair of spectacles of claim 19, wherein the translation mechanism is adapted to translate the first lens, the second lens, or both the first lens and the second lens relative to the frame.

21. The pair of spectacles of claim 1, wherein the translation mechanism is adapted to translate the frame relative to the wearer's face.

22. The pair of spectacles of claim 1, wherein the first lens is a multi-focal progressive addition lens, which functions in combination with the electro-active changeable focus optical zone of the first lens.

23. The pair of spectacles of claim 9, wherein the second lens is a multi-focal progressive addition lens, which functions in combination with the electro-active changeable focus optical zone of the second lens.

24. A method of correcting for night-time vision in a subject, comprising:
providing a pair of spectacles according to claim 1; and
translating the spectacles up or down the wearer's face in response to light conditions.

25. The method of claim 24, wherein the translating is carried out manually by the wearer.

26. The method of claim 24, wherein the translating is carried out by a mechanism adapted to translate the pair of spectacles up or down a wearer's face.

27. The method of claim 26, wherein the translating is carried out in response to the output of a photosensor.
